(19) United States
(12) Patent Application Publication
(10) Pub. No.: US 2006/0077029 A1
(43) Pub. Date: Apr. 13, 2006

(54) Apparatus and method for constructions of stacked inductive components

(75) Inventor: Thomas Koschmieder, Austin, TX (US)

Correspondence Address: TOLER & LARSON & ABEL, L.L.P., 5000 PLAZA ON THE LAKE SUITE 265, AUSTIN, TX, 78746, US

(73) Assignee: Freescale Semiconductor, Inc.

(21) Appl. No.: 10/960,676

(22) Filed: Oct. 7, 2004

(51) Int. Cl. H01F 27/28

(52) U.S. Cl. 336/223

(57) ABSTRACT

An inductive component is formed by stacking a plurality of layers of a strip comprising inductive element portions disposed at a flexible, non-conductive material to form a substrate, where each of inductive element portions is electrically coupled to an adjacent inductive element portion to form the inductive component.

### FIELD OF THE DISCLOSURE

The present disclosure relates generally to inductive components and methods of forming inductive components.

### BACKGROUND

Inductive components are commonly used in electronic applications. A common inductive element is an inductor formed of coils. One method of forming such inductors is to use standard printed circuit board (PCB) technology. However, inductors formed using standard PCB technology tend to be thick and rigid in construction, and are limited in the number of coils that can be used. Other types of inductors include ceramic inductors, whereby specific inductive structures are formed on different ceramic layers and connected through interlayer conductors. Ceramic inductors also tend to be thick and rigid in total construction, and can involve costly manufacturing. Traditional wrapped wire inductor coils are generally bulky, and not conducive to being placed by automated machinery.

Therefore, an apparatus or method overcoming these problems would be useful.

### BRIEF DESCRIPTION OF THE DRAWINGS

FIG. 1 illustrates, in block diagram form, a system including a inductive element in accordance with a specific embodiment to the present disclosure.

FIG. 2 illustrates, a plan view and cross-sectional view, of a strip of a non-conductive flexible material having a inductive component formed thereupon.

FIG. 3 illustrates a portion of the strip of FIG. 2 in greater detail.

FIG. 4 illustrates, a side view of a strip similar to that of FIG. 2 during a stacking step.

FIG. 5 though FIG. 7 illustrate representative side views of components stacked in accordance with specific embodiments of the present disclosure.

FIGS. 8 through 12 illustrate various steps in accordance with the manufacturing process of a strip in accordance with the present disclosure.

FIG. 13 illustrates a method and device whereby an interposing material is placed between inductive element portions of a component.

### DETAILED DESCRIPTION OF THE DRAWINGS

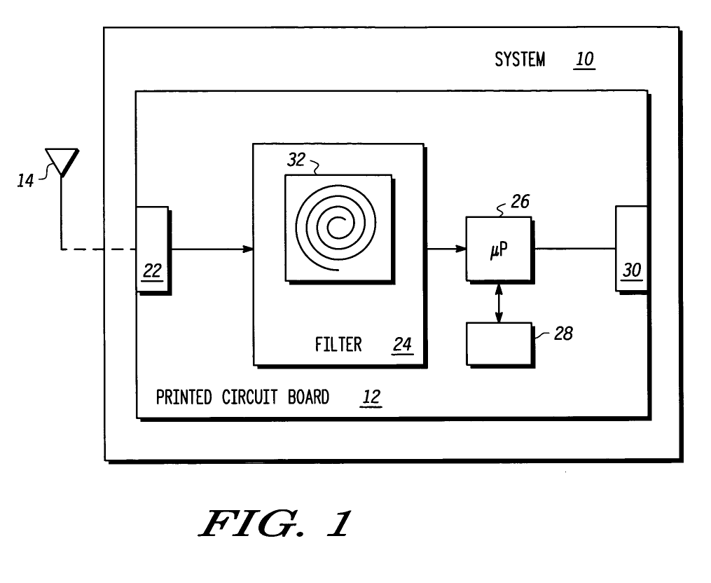

The following description is intended to convey a thorough understanding of the present disclosure by providing a number of specific embodiments and details involving the manufacture and formation of inductors by stacking basic building blocks that can be readily varied in number to achieve a desired inductance. The basic building blocks include inductor portions formed, for example, on or in a polyimide substrate, which, when folded, can be joined with portions of opposing surfaces of other inductor portions. The inductance of a specific component can be determined by selecting the number of building blocks to be joined together. Specific embodiments of the present disclosure are better understood with reference to FIGS. 1-13.

FIG. 1 illustrates a system 10 representing a specific application. Examples of applications represented by system 10 can include communication applications such wireless base stations and remote devices, such as cell phones, automotive electronic applications, as well as high-speed computing devices. The system 10 includes an application substrate 12, which is typically a printed circuit board, or other substrate that supports and connects components to perform a predefined function. The substrate 12 illustrated in FIG. 1 includes IO ports 22 and 30, a filter 24, a microprocessor 26, and other components 28. In operation, one or more signals are received at IO port 22, such as an RF signal received at antenna 14. Signals received at IO port 22 can be conditioned by filter 24. Filter 24 is illustrated to include an inductive component 32 that passively filters the received signal. The received signal can be further processed by components other than the inductive component 32 within filter 24 to perform a data recovery or other signal conditioning operations prior to being provided to a microprocessor 26 or other components 28 for further processing. Subsequent to any further processing by the microprocessor 26 and other components 28, information can be provided to the IO port 30.

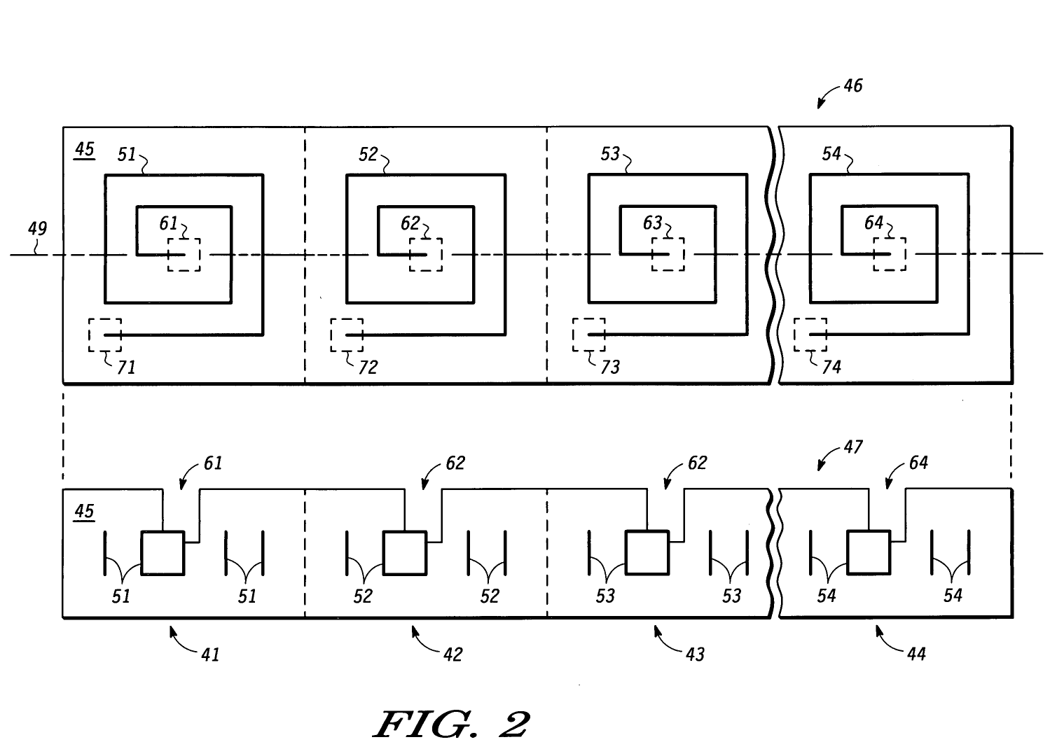

In accordance with a specific implementation of the present disclosure, the inductive component 32 includes a flexible, non-conductive substrate and a plurality of layers, each layer comprising a conductive material to provide a portion of the inductive element. Typically, the conductive material of each layer will be connected to a conductive material of at least one other layer through an interlayer connection generally referred to as a via. Through the use of a flexible non-conductive substrate at which the conductive materials are disposed, the inductive components described herein are particularly useful for environments where high physical stresses are encountered, and can be manufactured using low-cost materials and manufacturing processes. In a particular implementation, the inductive component 32 can be formed upon a strip of polyimide that is stacked upon itself during a manufacturing process used to form the inductive component. Specific implementations of forming the inductive component 32 will be better understood with respect to FIGS. 2 through 13.

FIG. 2 illustrates both a plan view 46, and cross-sectional view 47 of a strip 45 in accordance with the present disclosure. Typically, strip 45 is formed of a flexible substrate material that supports a conductive material forming inductive element portions. In one embodiment, the strip 45 is a polyimide material that can withstand temperatures associated with the formation and use of the inductive components described herein. One example of a readily available polyimide material that can be used to form the strip 45 is Kapton® polyimide film from DuPont, which has a high-temperature resistance.

Building block portions 41-44 are formed in or on the flexible substrate material of strip 45 in an adjacent manner and include inductive element portions 51-54 that are comprised of conductive materials, such as copper or aluminum, patterned to facilitate a specific inductive characteristic. Inductive element portions 51-54 are illustrated as individual spirals, each having slightly more than two windings. It will be appreciated that the number of windings formed at each individual portion 41-44, as well as the shape of the windings, can vary from those illustrated, and may be fractional, depending upon a desired resulting inductance. An example of a fractional number of windings would be inductive element portions each having one-half of a winding, which when connected together with other inductive element portions form an inductive component having a spiral structure with one or more full windings.

The portions 51-54 each facilitate a portion of an inductance of a finished component. For example, if four inductive element portions, each having 2 windings, are connected to form an inductor having a inductance of X, each portion 51-54 facilitates a portion of the inductance equal to approximately X/4. Further illustrated in the plan view of FIG. 2 are openings 61-64 and openings 71-74. The openings 61-64 and 71-74 facilitate electrically connecting a inductive element portion at one layer to an adjacent layer or to an external connection.

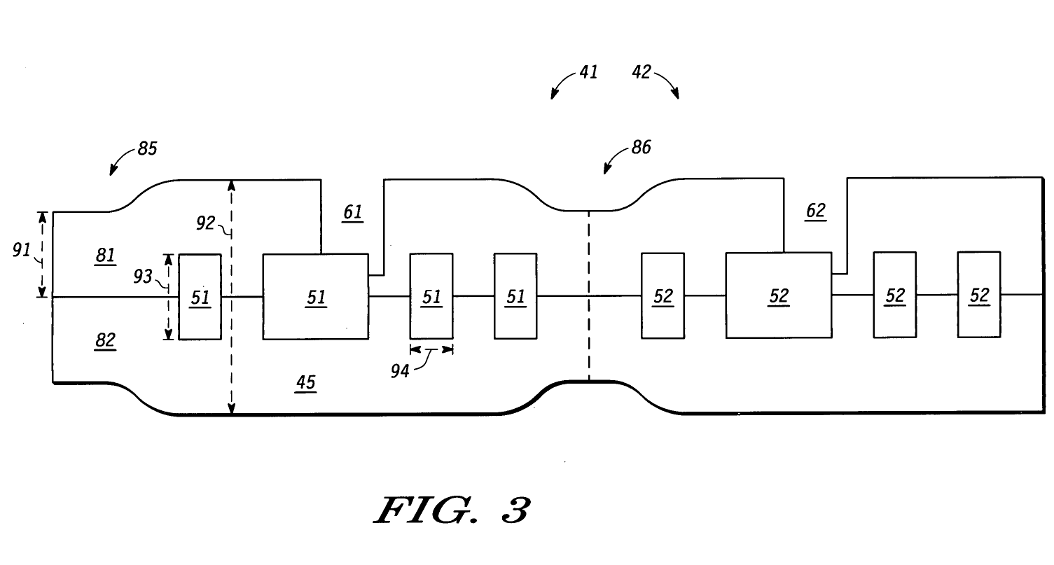

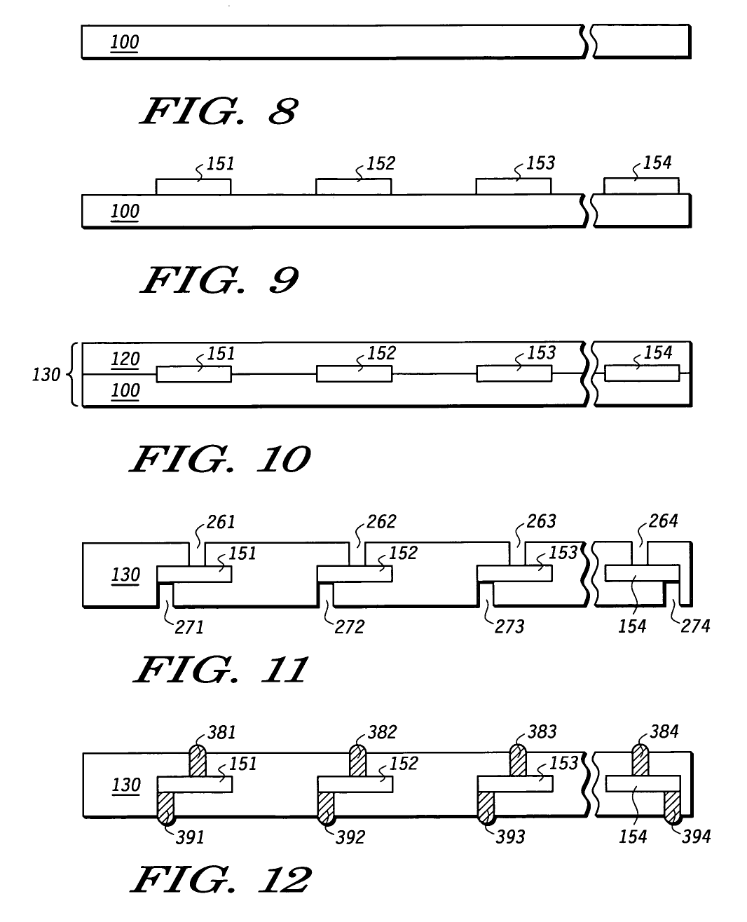

The dashed line 49 illustrated on the plan view 46 indicates where a cross-sectional view 47 of FIG. 2 is located. The cross-sectional view 47 illustrated in FIG. 2 indicates where specific portions of each inductive element 51-54 and openings 61-64 are located along intersecting line 49. It is specifically illustrated, that openings 61-64 facilitate access to a portion of a respective inductive element portion 51-54. The inductive element portions 51-54 are formed between upper and lower substrate portions, as is discussed in greater detail with reference to FIGS. 8-12 and illustrated in greater detail with reference to FIG. 3.

FIG. 3 illustrates a portion of the cross-section view 47 of FIG. 2 in greater detail. Specifically, FIG. 3 illustrates a more detailed view of portions 41 and 42 of the cross-sectional view 47 of FIG. 2.

A width 94 of inductive element portion 51 is indicated in FIG. 3, where width 94 is typically in the range from 0.1 microns to 100 microns or greater. In one embodiment, semiconductor fabrication processes can be used to fabricate the inductive element portions when dimensions near the lower end of this range are needed. In other embodiments, flex substrate printed circuit board technology can be used to fabricate the inductive element portions when larger widths are needed. A typical thickness 93 of the inductive element portions 51 and 52 is in the range of 0.1 microns to 40 microns. It will be appreciated, that the specific thickness and width of the conductive portions of 51 and 52 can vary significantly based upon the specific technologies being used, and the inductive characteristics desired.

Further illustrated, in FIG. 3 are recessed locations 85 and 86. The recessed locations 85 and 86 are formed by an absence of conductive material disposed between flexible substrate portions 81 and 82. The recesses 85 and 86 can help facilitate formation of specific folding locations for specific embodiments discussed herein.

Also illustrated in FIG. 3 is a thickness 91 indicating a typical thickness of a single sheet of a flexible non-conductive material, like a polyimide, overlying one side of an inductive element portion. For example, layers 81 and 82, in combination, surround the inductive element portions 51-54 in accordance with a specific embodiment of the present disclosure. It will be appreciated that the portions 81 and 82 may be of the same or different thicknesses. Typical thickness ranges of each flexible layer 81 and 82 are approximately 10 microns to 100 microns. The flexible layers 81 and 82 may be attached using adhesives or by other bonding techniques as needed.

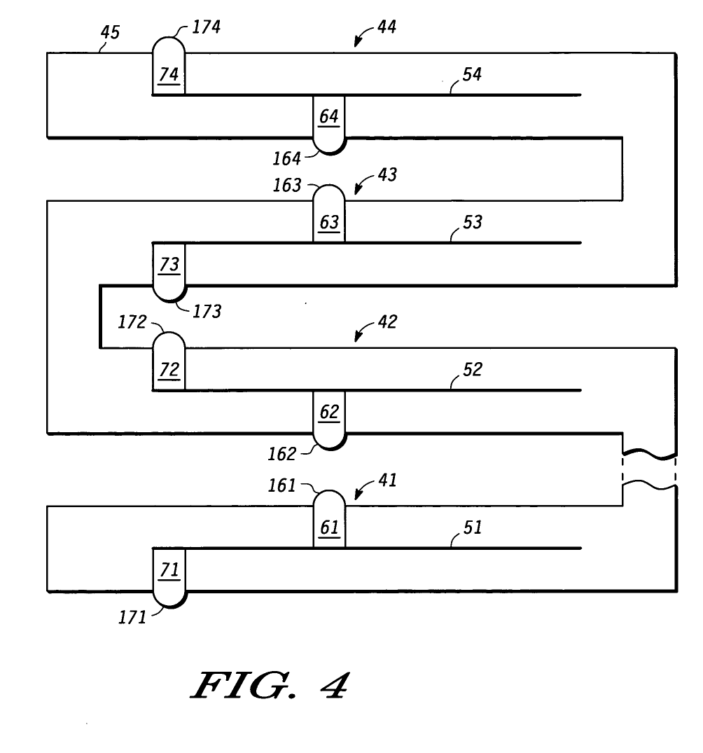

FIG. 4 illustrates strip 45 during a stacking process that folds the strip 45. Specifically, FIG. 4 illustrates strip 45 being folded in an accordion-type or z-fold manner. A continuous strip being folded in an accordion-type manner results in adjacent inductive portions confronting each other along a common surface of strip 45, whereby a layer of non-conductive material above a layer containing conductive portion 54 and a layer of non-conductive material below a layer containing conductive portion 53 comprise a continuous strip of flexible non-conductive material, and a layer of non-conductive material below the layer containing conductive portion 54 and a layer of non-conductive material above the layer containing conductive portion 53 comprise a continuous strip of flexible non-conductive material. For example, referring to FIG. 2, it is illustrated that openings 61 and 62 are formed at a common surface of the strip 45 in order to form a confronting pair of openings once folded, as illustrated in FIG. 4. As further illustrated in FIG. 4, openings 61 and 62 are aligned to facilitate electrically connecting portion 51 to portion 52. Strip 45 can also be stacked by folding in a wrap-type manner, whereby adjacent inductive portions confront each other along opposite surfaces of strip 45. See discussion regarding FIG. 6, infra, where a layer of non-conductive material above conductive portion 53 and a layer of non-conductive material above conductive portion 51 comprise a continuous strip of flexible non-conductive material, and a layer of non-conductive material below conductive portion 51 and a layer of non-conductive below conductive portion 53 comprise a continuous strip of the flexible non-conductive material.

During the folding process, openings having contacts, e.g., contacts 171-174 and 161-164, are substantially aligned to oppose each other, thereby facilitating the formation of electrical connections between adjacent inductive element portions 51-54. Openings 71 and 74 represent first and second terminals of a finished component.

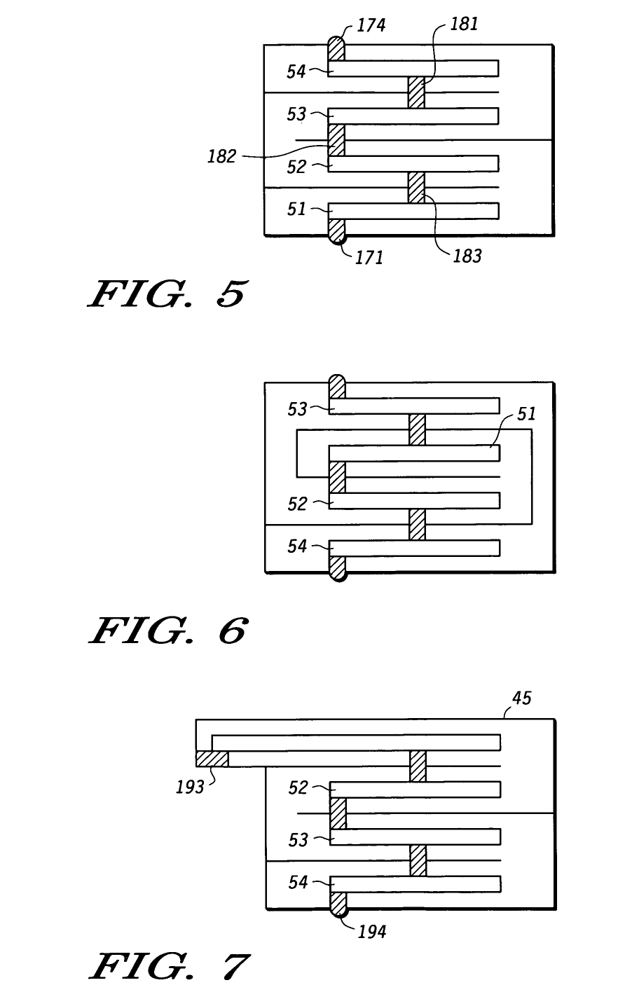

FIG. 5 illustrates a specific embodiment of a device using the stacking technique illustrated with reference to FIG. 4. The device of FIG. 5 comprises a layer of flexible, non-conductive material overlying the conductive portion 51, a layer of flexible non-conductive material between each of the conductive portions 51-54, and a layer of flexible non-conductive material underlying the conductive portion 54.

The stacking technique illustrated in FIG. 5 is implemented using the accordion-type folding procedure to align openings between inductive element portions 51 and 52, inductive element portions 52 and 53, and inductive element portions 53 and 54. It will be appreciated that while only four layers of basic building block portions have been illustrated, more or fewer layers may be implemented based upon a desired inductance. For example, should a greater inductance of a final component be desired, more layers would be formed by folding in additional inductive element portions. In an alternate embodiment, inductive element portions having more windings, or fewer windings, than those illustrated can be used to provide a desired inductance.

Specifically illustrated in FIG. 5 are conductive structures, contacts, electrically connecting the inductive element portions 51-54 to at least one adjacent inductive element portion at the openings 61-64, and 71-74. Conductive portions 171 and 172 facilitate connecting the inductive component of FIG. 5 to a substrate, such as a printed circuit board or package substrate. In one embodiment, the conductive portions at the via interconnects formed at each opening as previously disclosed, can be formed using surface mount pad technology that facilitates joining individual coils together using reflow techniques. For example, standard solder pastes and reflow furnaces can be used for creating the inductors illustrated.

FIG. 6 illustrates an alternate embodiment of an inductive component where a stacking technique that uses a wrap-type fold that wraps a strip containing inductive element portions around itself is used to form the component. For example, the component of FIG. 6 is considered to be wrapped because the conductive structure 51, which is a structure formed at the end of strip as in FIG. 2, is positioned on the interior, i.e., the center of the device, such that the adjacent inductive element 52 is folded to be below inductive element portion 51, and inductive element portion 53 is folded to be above inductive element portion 51. In this manner, an upper surface portion of the strip will confront a lower surface portion of the strip when wrapped. Note that the locations of the openings used in the embodiment of FIG. 6 are different than the location of the opening used in the embodiment of FIG. 5.

FIG. 7 illustrates an accordion folded strip similar to that described with respect to FIG. 5. However, FIG. 7 illustrates a portion of the strip extended past an underlying portion of the strip, whereby two conductive terminals 193 and 194 for externally interfacing the device at FIG. 7 are formed at a common side of the component.

FIGS. 8-12 illustrate a specific process of forming a strip to be stacked in a manner disclosed herein. FIG. 8 illustrates a strip portion 100 comprising a flexible, non-conductive material, such as a polyimide, prior to the formation of any subsequent structures.

FIG. 9 illustrates the polyimide strip portion 100 of FIG. 8 subsequent to the formation of inductive element portions 151-154. It will be appreciated that various methods of disposing the inductive element portions 151-154 exist. In one embodiment, the inductive element portions 151-154 can be disposed using an ink-jet deposition process. In an alternate embodiment, the inductive element portions 151-154 can be disposed using a masking technique whereby a conductive layer, such as a conductive copper layer, is disposed overlying the layer 100 followed by a masking layer overlying the conductive layer prior to etching any exposed underlying conductive material. In yet another embodiment, foil techniques are used, whereby pre-patterned conductive portions are disposed at the strip 100 using adhesive or pressing techniques to form the inductive element portions. With respect to the disposition of the specific inductive element portions 151-154, the space in between specific inductive element portions can vary depending upon the folding technique utilized. For example, where an accordion folding technique is utilized, the space in between any two element portions can be substantially the same. However, where wrapping techniques are used to create the folded device, the space between individual inductive element portions will typically vary depending upon where in the wrapped stack its adjacent inductive elements are to be located.

FIG. 10 illustrates the strip portion 100 of FIG. 9 having a subsequent strip portion 120 disposed over the strip portion 100 to enclose the inductive element portions. In a specific embodiment, the strip portion 120 further comprises a polyimide material whereby the inductive element portions 151-154 are encapsulated within the polyimide substrate 130 formed by the separate portions 100 and 120. It will be appreciated that any encapsulation method can be utilized to isolate two inductive elements from each other. The portions 120 and 100 can be held together by an adhesive material or other bonding techniques as needed.

FIG. 11 illustrates the substrate 130 of FIG. 10 subsequent to the formation of openings 261-264 and 271-274. It will be appreciated that the openings 261-264 and 271-274 may be formed prior to, during, or subsequent to the encapsulation of portions 151-154. For example, the openings 261-264 and 271-274 can be formed using a variety of processes such as a chemical etch process or a laser cutting process, subsequent to encapsulation of the inductive element portions 151-154 within the flexible substrate 130. Alternatively, the polyimide layers 100 and 120 can be formed with precut openings to which to the inductive element portions 151-154 are aligned during the manufacturing process. Precut openings can be formed using chemical, laser, or stamping technology. In yet another embodiment, only one of layers 100 and 120 has precut openings, while the other layer's openings are formed using an alternative process, such as a chemical etch or laser cutting process.

FIG. 12 illustrates the substrate 130 illustrated in FIG. 11 subsequent to the deposition of conductive structures within the openings 261-264 and 271-274. The conductive structures 381-384 and 391-394 can comprise conductive adhesives, solder pastes, or discrete structures, such as pins, studs, or balls. Larger dimensioned conductive structures can be formed using solder screen print techniques and wave solder techniques. Smaller features and better control can be obtained using ink-jet technology.

Subsequent to the formation of the strip illustrated in FIG. 12, it will be appreciated, as previously described herein, that the strip may be folded at locations residing between the individual inductive elements 151-154 that facilitate the stacking of the inductive element portions such that their conductive structures 381-384 and 391-394 are aligned to facilitate the forming of inductive devices similar to those described and illustrated with reference to FIGS. 5 through 7. It will be further appreciated, that additional processing steps may be required depending upon the conductive material utilized within the strip. For example, where solder components are used, reflow techniques typically will be utilized to facilitate the electrical coupling between the inductive element portions.

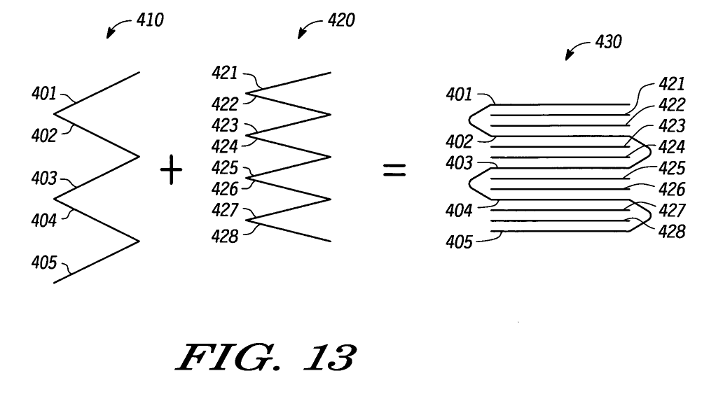

FIG. 13 illustrates an embodiment, where an interposing material 420, such as a ferro-magnetic material, which may be patterned, is placed between each of the inductive element portions. Specifically, inductive element portions 401-405 are illustrated being stacked in an accordion-type manner. Also folded in an accordion-type manner is a material that is to reside between each of the inductive element portions 401-405. As illustrated in the component of FIG. 13, one fold of interposing material 420 is inserted between each adjacent inductive element portion. For example, the fold formed by portions 421 and 422 is inserted between inductive element portions 401 and 402; the fold formed by portions 423 and 424 is inserted between inductive element portions 402 and 403; the fold formed by portions 425 and 426 is inserted between inductive element portions 403 and 404; the fold formed by portions 427 and 428 is inserted between inductive element portions 404 and 405. Note that the folds of material 420 are inserted between the layers of folded strip 410 such that folds of the folded strip 410, which contains the inductive element portions, are perpendicular to the sheet on which FIG. 13 is illustrated, while the folds of the interposing material 420 are parallel to the sheet of FIG. 13, i.e. the folds of strip 410 are substantially perpendicular to the folds of material 420 in the component 430.

The present disclosure is not limited to these specific embodiments and details, which are exemplary only. It is further understood that one possessing ordinary skill in the art, in light of known systems and methods, would appreciate the use of the disclosure for its intended purposes and benefits in any number of alternative embodiments, depending upon specific design and other needs. For example, though not specifically illustrated, the building block portions may be physically separated from each other and stacked like a deck of cards to form components. In addition, unconventional folding techniques, which can include rolling, can be used, such as folding a strip end-to-end one or more times, and a Mobius folding. In another embodiment, mechanical through holes can exist in the flexible substrate portions.

What is claimed is:

1. An apparatus comprising:
a plurality of layers, each layer comprising:
a conductive material to provide a portion of an inductive element; and
a flexible, non-conductive substrate substantially enclosing the conductive material;
wherein the conductive material of each of the plurality of layers is electrically coupled to the conductive material of one or more adjacent layers.

2. The apparatus of claim 1, wherein the flexible, non-conductive substrate comprises a polyimide material.

3. The apparatus of claim 1, wherein the conductive material of each the plurality of layers is electrically coupled to the conductive material of one or more adjacent layers using a solder.

4. The apparatus of claim 1, wherein the non-conductive substrate is folded in one of an accordion-type fold or a wrap-type fold.

5. The apparatus of claim 1, further comprising ferro-magnetic material disposed between one or more adjacent layers of the plurality of layers.

6. An apparatus comprising:
a strip of flexible non-conductive material; and
a plurality of conductive material portions disposed in the strip, each conductive material portion to provide a respective portion of an inductive element;
wherein the strip is folded between adjacent conductive material portions of the plurality of conductive material portions so that a first portion of a side of the strip is aligned to a second portion of a side of the strip.

7. The method of claim 6, wherein the first portion of the side of the strip and the second portion of the side of the strip are on a same side of the strip.

8. The method of claim 6, wherein the first portion and the second portion are on different sides of the strip.

9. The method of claim 6, wherein a first conductive material portion and a second conductive material portion of the plurality of conductive material portions are electrically coupled at a location of the first portion of the side of the strip.

10. The method of claim 6, further comprising electrically coupling each conductive material portion to at least one adjacent conductive material portion.

11. The method of claim 6, further comprising placing one or more strips of ferro-magnetic material between the folds of the strip of flexible non-conductive material.

12. A method comprising:
providing a first layer of flexible non-conductive material;
disposing a plurality of conductive material portions at the first layer of flexible non-conductive material;
providing a second layer of flexible non-conductive material overlaying the first layer of flexible non-conductive material and the plurality of conductive material portions; and
folding the first and second layers of flexible non-conductive material between the plurality of conductive material portions.

13. The method of claim 12, wherein the first and second layers are folded so that a first portion of the first layer is adjacent to a second portion of the first layer.

14. The method of claim 13, wherein a first conductive material portion and a second conductive material portion of the plurality of conductive material portions are electrically coupled at the first and second portions.

15. The method of claim 12, wherein the first and second layers are folded so that a first portion of the first layer is adjacent to a second portion of the second layer.

16. The method of claim 15, wherein a first conductive material portion and a second conductive material portion of the plurality of conductive material portions are electrically coupled via the first and second portions.

17. An inductive element comprising:
a first flexible non-conductive layer;
a second flexible non-conductive layer adjacent to the first flexible non-conductive layer;
a third flexible non-conductive layer adjacent to the second flexible non-conductive layer;
a fourth flexible non-conductive layer adjacent to the third flexible non-conductive layer;
a first conductive material portion disposed between the first and second flexible non-conductive layers, wherein the first conductive material portion is to provide a first portion of a an inductive element;
a second conductive material portion disposed between the third and fourth flexible non-conductive layers, wherein the second conductive material portion is to provide a second portion of the reactive element; and
wherein the first conductive material portion and the second conductive material portion are electrically coupled through the second and third flexible non-conductive layers.

18. The inductive element of claim 17, wherein at least one of the first, second, third or fourth flexible, non-conductive layers comprises a polyimide material.

19. The inductive element of claim 17, wherein the first and fourth flexible non-conductive layers together comprise a first continuous strip of flexible non-conductive material and wherein the second and third flexible non-conductive layers together comprise a second continuous strip of flexible non-conductive material.

20. The inductive element of claim 17, wherein the first and third flexible non-conductive layers together comprise a first continuous strip of flexible non-conductive material and wherein the second and fourth flexible non-conductive layers together comprise a second continuous strip of flexible non-conductive material.

21. The inductive element of claim 17, further comprising:
a first opening in the second flexible non-conductive layer;
a second opening in the third flexible non-conductive layer that is substantially aligned with the first opening; and
a solder disposed at the first and second openings, wherein the solder via is electrically coupled to the first and second conductive material portions.
